(19) United States
(12) Patent Application Publication
(10) Pub. No.: US 2013/0024425 A1
(43) Pub. Date: Jan. 24, 2013

(54) BACKUP FILE PRIORITY SYSTEM AND METHOD

(71) Applicants: Ai Huang, Beijing (CN); Chong Wang, Beijing (CN)

(72) Inventors: Ai Huang, Beijing (CN); Chong Wang, Beijing (CN)

(73) Assignee: COMPUTER ASSOCIATES THINK, INC., Islandia, NY (US)

(21) Appl. No.: 13/184,821

(22) Filed: Jul. 18, 2011

(51) Int. Cl. G06F 12/16; G06F 17/30

(52) U.S. Cl. 707/650; 707/E17.005

(57) ABSTRACT

A system and method include initiating a backup of system files on a computer system. A user selected priority is checked for each file. Files having a higher user selected priority are backed up prior to attempting to back up files having a lower user selected priority, wherein the files are backed up to a storage device as a function of storage space available on the storage device.

### BACKGROUND

Backup systems for backing up data in information handling systems can involve large storage devices. Data storage needs keep increasing, and unless the storage capacity of the backup systems is increased, there may be times when a backup system does not have the storage capacity to store all the data being used by an information handling system. In some prior backup systems, a check is done for sufficient storage prior to starting the backup. In others, the backup system simply runs out of storage during a backup operation. If the information handling system crashes without a complete backup, data may be lost.

### SUMMARY

A system and method include initiating a backup of system files on a computer system. A user selected priority is checked for each file. Files having a higher user selected priority are backed up prior to attempting to back up files having a lower user selected priority, wherein the files are backed up to a storage device as a function of storage space available on the storage device.

In one embodiment, the method is encoded in computer readable instructions on a computer readable storage device.

In a further embodiment, a system includes a module to initiate a backup of system files on a computer system, a module to read a user selected priority for a file, a module to compare the user selected priority for the file to the user selected priority of other files, and a module to back up files having a higher user selected priority, wherein the files are backed up to a storage device as a function of storage space available on the storage device.

### BRIEF DESCRIPTION OF THE DRAWINGS

FIG. 1 is a block diagram of a backup system utilizing backup priorities for files according to an example embodiment.

FIG. 2 is a chart illustrating file backup priorities based on file type according to an example embodiment.

FIG. 3 is a flowchart illustrating a method of backing up files by priority according to an example embodiment.

FIG. 4 is a block diagram of a computer system for implementing one or more backup algorithms according to an example embodiment.

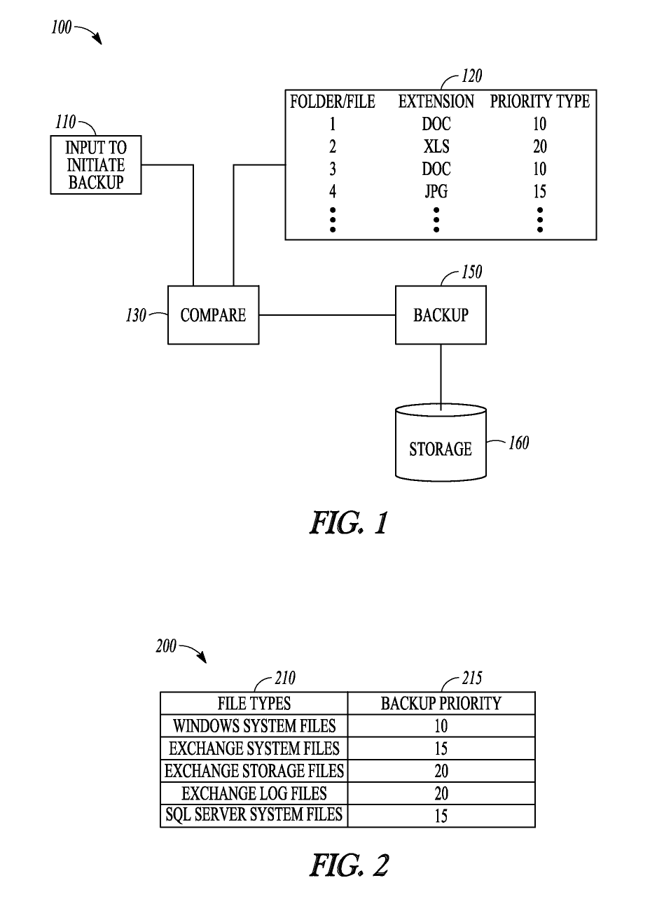

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that structural, logical and electrical changes may be made. The following description of example embodiments is, therefore, not to be taken in a limited sense, and the scope is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In various embodiments, an information backup system backs up files of a user system according to file backup priorities and as a function of storage space available on a backup storage device. The file backup priorities may be user selected, and may be assigned based on file type, or other attributes of the files, such as by folder, or even on an individual file basis.

A block diagram of a backup system 100 for backing up files includes an input 110 to initiate backup and also to select file backup priorities. A file table is indicated at 120, and contains information about user files to be backed up, including attributes such as file name, folder, file extension, file type, and a user assigned priority. In some embodiments, the attributes may be stored on a user computer to be backed up, and read into table 120 as needed, or may be stored in a separate table 120 for each user system to be backed up. In some embodiments the user may select to use default priorities, or may customize the priority according to selected attributes of each file. The user may set backup priorities based on file extension by using commands such as “Set *.jpg to 10”; “Set *.doc to 20”.

A compare module 130 compares the backup priorities of the files 120 to perform a backup 150 of the files. The compare module 130 selects the files according to backup priority and provides the files to be backed up to backup module 150, which stores the files in a backup storage device 160, also referred to as a target media. In one embodiment, files having a higher user selected priority are backed up prior to attempting to back up files having a lower user selected priority. If storage space is low, at least the highest priority files will be saved.

In one embodiment, a default backup priority is set to 0 for each file. As illustrated at 200 in a table of FIG. 2 having a column 210 corresponding to file types, and a column 215 corresponding to backup priority, users can select the backup priority based on file type. For example, if the user selects a priority of 10 for Windows system files, the backup system will set backup priorities of all Windows system files to 10. As seen in chart 200, Exchange system files have a priority of 15, Exchange storage files have a priority of 20, Exchange log files have a priority of 20, and SQL server system files have a priority of 15. The actual numbers used for priority are shown in increments of 5, but may be any other number or symbol desired, such as letters or other symbols capable of representing different priorities.

In a further embodiment, users may select backup priorities based on folders. For example, if a user sets a backup priority of one folder to 15, the backup priorities for all files in the folder are set to 15. If the user creates a new file in the folder, that file is also given a backup priority of 15. In still further embodiments, backup priorities may be set by the user at a file level in addition to the type, extension, or folder level. For example, a user may set a backup priority of SQL server db file type to 20, and then can manually modify the backup priority of one or more SQL db files.

In a further embodiment, a priority bar may be used to identify which files are important, and which files are normal. To identify important files, the backup priority of the file is compared to a predetermined backup up priority bar. If the backup priority of the file is more than or equal to the number of the priority bar, the file is considered an important file, and will be backed up. If the number of the backup priority for a file is less than the number of the priority bar, the file is considered a normal file, and may not be backed up if backup space is limited.

The priority bar may also be used to clean up old backed up data to make room for new data to be backed up. Users may set the backup priority bar as desired, and if not set up, the backup system may back up files based on the backup priority of each file. If users agree, and enable a setting for removal of old backed up data, a policy regarding the age of files may be used to remove files, such as only removing data that was stored 5 days ago or earlier. Further, if a user sets the backup priority bar, users can decide whether one backup session is separated into two child backup sessions or not. One child backup session may be devoted to important files, and the other may be devoted to normal files.

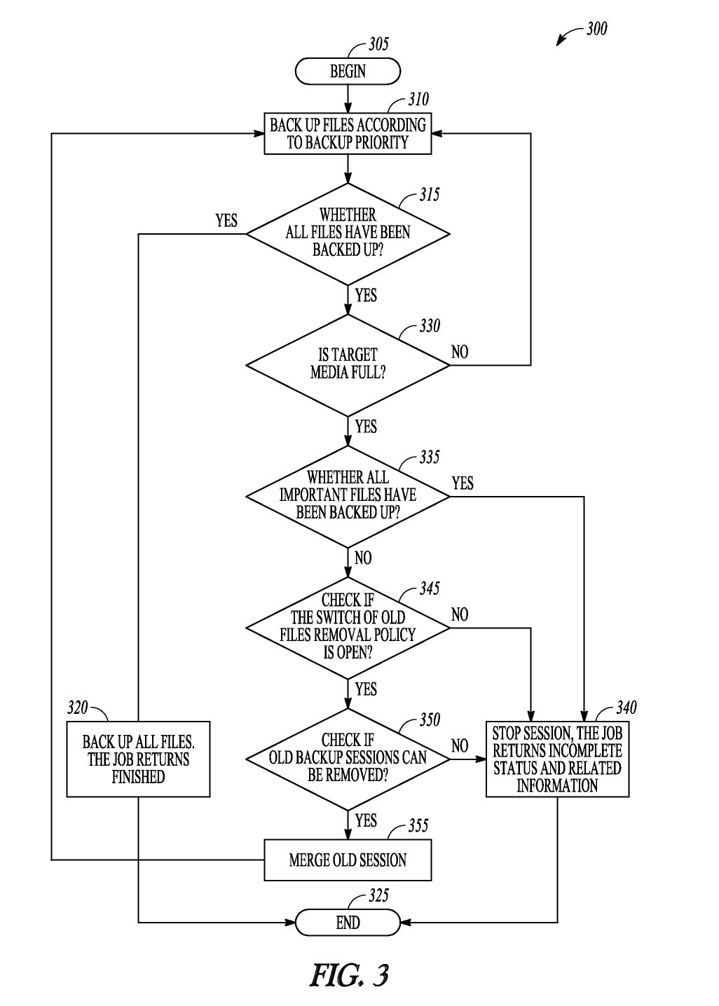

FIG. 3 is a flowchart of a method 300 for backing up files in accordance with a priority associated with the files. The method begins at 305. At 310, files stored on a system are backed up according to a backup priority. In various embodiments, priorities may be defined by a user, or a default priority may be assigned by an administrator, manufacturer or seller of the system. The files may be backed up in order of priority in one embodiment, such as when available backup storage space, referred to as target media, is insufficient to store all the date. In such a case, the files may be backed up starting with files having the highest priority. In a further embodiment, files with priority equal to or above the defined bar are backed up. The files with priority equal to or above the defined bar may be backed in an order with highest priority files backed up first, or without regard to file priority. If there is sufficient backup storage, all the files may be backed up in the desired order of priority.

At 315, the method determines whether all the files have been backed up. If all the files have been backed, up, the backup job returns at 320 and the method ends at 325. If all the files have not been backed up, the method determines whether the backup storage, referred to as the target media is full at 330. If not, backing up files continues at 310. If the target media is full as determined at 330, a determination is made at 335 as to whether or not all the higher priority files have been backed up. If yes, the method ends at 340 by stopping the backup session and returning an incomplete status along with related information.

If all the higher priority files have not been backed up as determined at 335, a check is made at 345 to determine if a switch of old files is enabled. If no, then the method ends at 340 as described. If yes, a check is made at 350 to determine if old backup sessions can be removed from the target media to make room for more files in the current backup session. If yes, old sessions may be merged at 355, and the method returns to 315 to backup more files according to the backup priority.

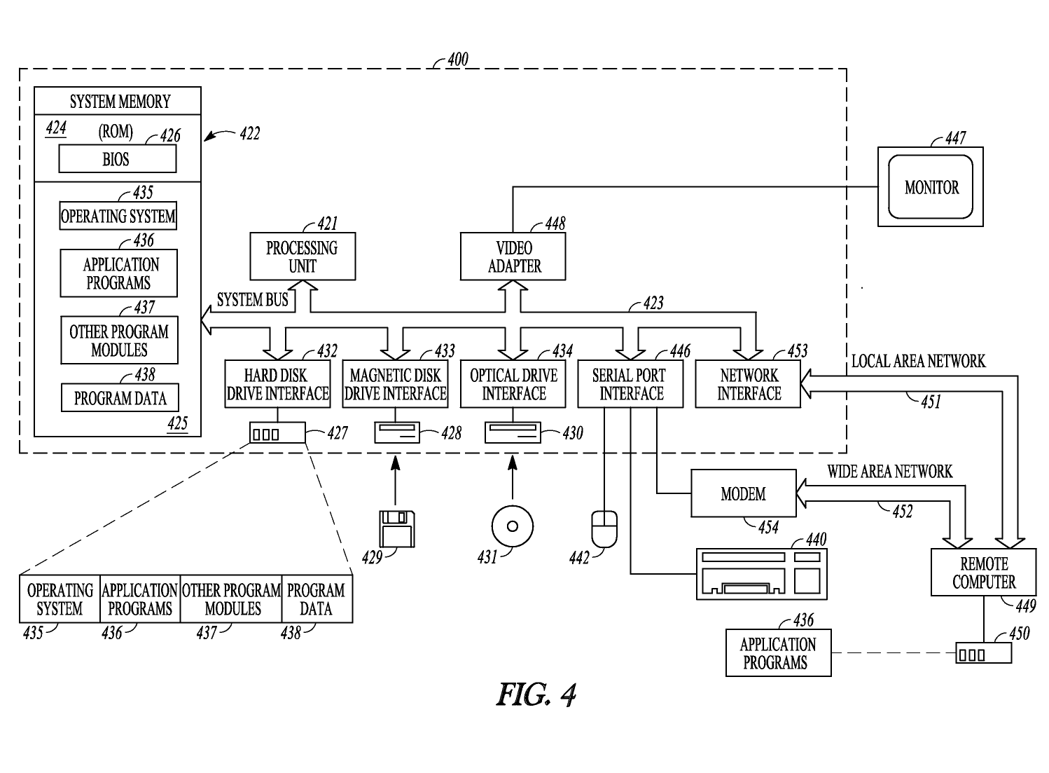

FIG. 4 is a block diagram of a computer system to implement methods according to an example embodiment. In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 400 (e.g., a personal computer, workstation, or server), including one or more processing units 421, a system memory 422, and a system bus 423 that operatively couples various system components including the system memory 422 to the processing unit 421. There may be only one or there may be more than one processing unit 421, such that the processor of computer 400 comprises a single central-processing unit (CPU), or a plurality of processing units, commonly referred to as a multiprocessor or parallel-processor environment. In various embodiments, computer 400 is a conventional computer, a distributed computer, or any other type of computer.

The system bus 423 can be any of several types of bus structures including a memory bus or memory controller, a peripheral bus, and a local bus using any of a variety of bus architectures. The system memory can also be referred to as simply the memory, and, in some embodiments, includes read-only memory (ROM) 424 and random-access memory (RAM) 425. A basic input/output system (BIOS) program 426, containing the basic routines that help to transfer information between elements within the computer 400, such as during start-up, may be stored in ROM 424. The computer 400 further includes a hard disk drive 427 for reading from and writing to a hard disk, not shown, a magnetic disk drive 428 for reading from or writing to a removable magnetic disk 429, and an optical disk drive 430 for reading from or writing to a removable optical disk 431 such as a CD ROM or other optical media.

The hard disk drive 427, magnetic disk drive 428, and optical disk drive 430 couple with a hard disk drive interface 432, a magnetic disk drive interface 433, and an optical disk drive interface 434, respectively. The drives and their associated computer-readable media provide non volatile storage of computer-readable instructions, data structures, program modules and other data for the computer 400. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 429, optical disk 431, ROM 424, or RAM 425, including an operating system 435, one or more application programs 436, other program modules 437, and program data 438. Programming for implementing one or more processes or method described herein may be resident on any one or number of these computer-readable media.

A user may enter commands and information into computer 400 through input devices such as a keyboard 440 and pointing device 442. Other input devices (not shown) can include a microphone, joystick, game pad, satellite dish, scanner, or the like. These other input devices are often connected to the processing unit 421 through a serial port interface 446 that is coupled to the system bus 423, but can be connected by other interfaces, such as a parallel port, game port, or a universal serial bus (USB). A monitor 447 or other type of display device can also be connected to the system bus 423 via an interface, such as a video adapter 448. The monitor 447 can display a graphical user interface for the user. In addition to the monitor 447, computers typically include other peripheral output devices (not shown), such as speakers and printers.

The computer 400 may operate in a networked environment using logical connections to one or more remote computers or servers, such as remote computer 449. These logical connections are achieved by a communication device coupled to or a part of the computer 400; other types of communication devices may also be used. The remote computer 449 can be another computer, a server, a router, a network PC, a client, a peer device or other common network node, and typically includes many or all of the elements described above I/O relative to the computer 400, although only a memory storage device 450 has been illustrated. The logical connections depicted in FIG. 4 include a local area network (LAN) 451 and/or a wide area network (WAN) 452. Such networking environments are commonplace in office networks, enterprise-wide computer networks, intranets and the internet, which are all types of networks.

When used in a LAN-networking environment, the computer 400 is connected to the LAN 451 through a network interface or adapter 453, which is one type of communications device. In some embodiments, when used in a WAN-networking environment, the computer 400 typically includes a modem 454 (another type of communications device) or any other type of communications device, e.g., a wireless transceiver, for establishing communications over the wide-area network 452, such as the internet. The modem 454, which may be internal or external, is connected to the system bus 423 via the serial port interface 446. In a networked environment, program modules depicted relative to the computer 400 can be stored in the remote memory storage device 450 of remote computer, or server 449. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

1. A method comprising:
initiating a backup of system files on an information handling system;
checking a user selected priority for each file; and
backing up files having a higher user selected priority prior to attempting to back up files having a lower user selected priority as a function of storage space on a backup target media.

2. The method of claim 1 wherein the user selected priority is applied as a function of file type.

3. The method of claim 1 wherein the user selected priority is applied as a function of file extension.

4. The method of claim 1 wherein the user selected priority is applied to folders.

5. The method of claim 1 wherein the user selected priority is applied to individual files.

6. The method of claim 1 wherein the higher user selected priority comprises files having a priority higher than or equal to a user selected bar.

7. The method of claim 6 and further comprising removing backed up files older than a user specified age.

8. The method of claim 1 wherein backup of higher priority and lower priority files is broken into separate backup sessions.

9. A computer readable storage device having instructions stored thereon to cause a computer to execute a method comprising:
initiating a backup of system files on a computer system;
reading a user selected priority for a file;
comparing the user selected priority for the file to that of other files; and
backing up files having a higher user selected priority to a backup storage device as a function of storage space available on the backup storage device.

10. The computer readable storage device of claim 9 wherein the user selected priority is applied as a function of file type.

11. The computer readable storage device of claim 9 wherein the user selected priority is applied to one of a function of file extension, folders, and individual files.

12. The computer readable storage device of claim 9 wherein the higher user selected priority comprises files having a priority higher than or equal to a user selected bar.

13. The computer readable storage device of claim 12 wherein the method further comprises removing backed up files older than a user specified age.

14. The computer readable storage device of claim 9 wherein backup of higher priority and lower priority files is broken into separate backup sessions.

15. A backup system comprising:
a module to initiate a backup of system files on a computer system;
a module to read a user selected priority for a file;
a module to compare the user selected priority for the file to the user selected priority of other files; and
a module to back up files having a higher user selected priority, wherein the files are backed up to a storage device as a function of storage space available on the storage device.

16. The system of claim 15 wherein the user selected priority is applied as a function of file type.

17. The system of claim 15 wherein the user selected priority is applied to one of a function of file extension, folders, and individual files.

18. The system of claim 15 wherein the higher user selected priority comprises files having a priority higher than or equal to a user selected bar.

19. The system of claim 18 wherein the method further comprises removing backed up files older than a user specified age.

20. The system of claim 15 wherein backup of higher priority and lower priority files is broken into separate backup sessions.
